(19) United States
(12) Patent Application Publication
(10) Pub. No.: US 2024/0037586 A1
(43) Pub. Date: Feb. 1, 2024

(54) INFLUENCE SCORING FOR SEGMENT ANALYSIS SYSTEMS AND METHODS

(71) Applicant: Verint Americas Inc., Alpharetta, GA (US)

(72) Inventors: Hamed Janani, Vancouver (CA); Anirudh Challa, Burnaby (CA); Hong Wang, San Mateo, CA (US); Mohamad Al-Sharara, Westmount (CA); José R. Benkí, Ann Arbor, MI (US); Zealand Cooley, Albion, MI (US); Danielle Vesia, San Mateo, CA (US)

(73) Assignee: Verint Americas Inc., Alpharetta, GA (US)

(21) Appl. No.: 17/873,271

(22) Filed: Jul. 26, 2022

(51) Int. Cl. G06Q 30/02

(52) U.S. Cl. CPC G06Q 30/0203; G06Q 30/0204; G06Q 30/0201

(57) ABSTRACT

The segment analysis system analyzes survey data to determine the influence each custom question/response combination (segment) has on a given aggregate scored survey metric for a given date/date range. The system removes from consideration all surveys that do not include a scored survey metric and date that matche the aggregate scored survey metric and given date/date range. The system further removes from consideration all surveys not pertaining received user-defined filtering. Once the system has eliminated all extraneous surveys from consideration, the system segments each question/response combinations across the pool of surveys to generate an influence score for each question/response combination. The system identifies which segment has the greatest positive and negative influence on the aggregate scored survey metric for the given date/date range. The system generates reports for the segment analysis and stores all segment analyses for further comparative analysis.

### FIELD

The present disclosure is directed to generating influence determinations for aggregate score data for segments of collected data.

### BACKGROUND

Many customer service companies and organizations send and receive customer surveys in an effort to determine many aspects pertaining to how satisfied customers are, the success of products, areas requiring improvement, etc. To make the most of the customer survey results, companies attempt to generate scores and other metrics so the company can compare survey results over time. Due to the volume of survey data, traditional systems are focused on collecting data, categorizing data, scoring data for different metrics the company would like to score, and analyzing the scored metrics over time to provide indications regarding the trajectory of the metrics. One use case for the analysis of scoring metrics is to identify which questions included in the surveys have the greatest influence on the scored metric. These questions may include demographic information (e.g., male/female, state of residence, age, etc.) and completion/satisfaction of purpose information (e.g., were you looking to purchase an airline ticket today, did you purchase an airline ticket today, were you pleased with your user experience?). However, current systems only provide the data metric information and scores, leaving companies to manually analyze the metrics and scores in an attempt to determine what questions contributed the greatest influence on the scored metric.

Traditional analysis of survey statistics scores generally involves the comparison of mean scores for question/response combinations selected by an analyst but does not account for the number of responses for the question/response combination, thereby not providing an accurate indication of impact across all surveys. Further, traditional analysis of survey statistics scores does not allow for cross-question/response combination comparisons as the analysis of each question/response combination is not normalized.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, according to certain embodiments a method is disclosed that includes receiving a set of survey score data for a specific set of surveys from a survey scores database based on the request data. The method includes analyzing the set of survey score data to eliminate one or more surveys from the set of surveys in the set of survey score data that do not correspond to received user-defined purpose information. The method furthermore includes generating a set of score information from each survey in the set of survey score data, the set of score information including a score for a scored survey metric corresponding to the aggregate scored survey metric. The method in addition includes determining a score count for the set of survey score data, the score count being a number of surveys in the set of survey score data. The method moreover includes analyzing the set of survey score data to generate segment score data for each question/response combination of a plurality of question/response combinations in the set of surveys of the set of survey score data, the segment score data including the score for the scored survey metric corresponding to the aggregate scored survey metric for each survey including a specific question/response combination and the specific question/response combination. The method also includes passing all segment score data, the score information, and the survey count to an analysis component for influence determination. The method furthermore includes generating, by the analysis component, influence data for each segment score data based on the score information and the survey count, each influence data including an influence score for the question/response combination associated with a segment score data, the question/response combination associated with the segment score data, and the request data. The method moreover includes generating an influence score report for the request data based on analysis of the influence scores of the influence data. Other embodiments of this aspect include corresponding computer systems, apparatus, and computer programs recorded on one or more computer storage devices, each configured to perform the actions of the methods.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

### BRIEF DESCRIPTION OF THE DRAWING(S)

FIG. 1A depicts an example of a segment analysis system, according to certain embodiments.

FIG. 1B depicts an example of a preprocessing component used in the segment analysis system, according to certain embodiments

FIG. 2 depicts a flowchart of an example of a method for preparing survey data to generate influence data, according to certain embodiments

FIGS. 3A and 3B depict a flowchart of an example of a method for segment analysis using influence scoring, according to certain embodiments.

FIGS. 4A and 4B depict a flowchart of an example of a method for segment analysis using influence scoring, according to certain embodiments.

FIG. 5 depicts an example diagram of a computer system that may be utilized to implement segment analysis in accordance with the disclosure according to certain embodiments.

### DETAILED DESCRIPTION

For companies and organizations looking to maximize the value of survey data, there is an unmet need in the art for a system capable of identifying which questions impact an aggregate scored survey metric the most for a group of surveys. Identifying questions with the most influence on an aggregate scored survey metric allows companies insight into which factors contribute most to the aggregate scored survey metric. If, for example, a positive anomaly was detected for customer satisfaction score on a given day/date range, the segment analysis would allow a company to identify the questions/factors in the survey data having the greatest positive influence on the customer satisfaction score for the given day/date range. Therefore, there is an additional need in the art for a system that standardizes the statistical analysis of each question/response combination across a group of surveys so that cross-question comparison of influence is easily obtained. Influence scoring allows for the comparison of all question/response combinations for a group of surveys with a scored survey metric in common to identify which question/response combinations have the greatest influence on the aggregate scored survey metric. Influence scoring in segmented survey data allows a company to quickly pinpoint and identify reasons end-users were satisfied or dissatisfied with customer support, identify what types of customers like/dislike new products, what factors most influence an end-user's satisfaction with their experience, etc. Further, influence scoring in segmented survey data allows a company insight into which factors contribute most to the aggregate scored survey metric at a given time, rather than prescribing the same importance to each factor for all time. This allows a company to determine how the importance of different factors may change over time.

There is further an unmet need in the art for a system capable of allowing companies to customize and specify what survey data to consider when identifying the factors that most influence a scored metric. This ability to customize allows the user (company) a precise and in-depth ability to analyze factors contributing to very specific aspects of their survey data. For example, if the user wanted to know what questions/factors had the greatest impact on customer satisfaction for end-users looking to make a product purchase, it would not be beneficial for the system to include survey data in its analysis where end-users were looking for customer support on a problem even though those end-users may have also provided surveys impacting the customer satisfaction scored metric. The customization allows the user to drill down to very specific details and aspects it is looking to analyze and filter out survey data not contributing to that specific aspect/detail.

A segment analysis system is capable of segmenting and analyzing survey data for a given date/date range and a given aggregate score metric to identify the impact each question/factor of the survey data has on the score for the given metric and given date/date range. The system can then identify which questions/factors have the greatest impact on the score for the given aggregate metric and given date/date range and provide the user with this analysis. The aggregate scored survey metrics are based on survey data provided by an end-user and, according to certain embodiments, may be recently completed by the end-user relative to the time that segment analysis is carried out as disclosed herein. Surveys are generally made up of several types of questions: model questions/scored questions, custom questions, and free response questions. In this context, model questions/scored questions are questions on a survey that are given a numerical score and are used to generate a survey score for scored survey metrics. Custom questions are all questions on a survey that have yes/no and or provided multiple choice responses (e.g., question asking to pick from a given list a state of residence, question asking to pick from provided options the purpose for calling customer service, etc.) which are generally demographic type questions or purpose type questions. Free response questions are questions that ask an open-ended question and allow an end-user to write/type a response to the question.

The segment analysis system analyzes survey data to determine the influence each custom question/response combination (segment) has on a given aggregate scored survey metric for a given date/date range. First, the system removes from consideration all surveys that do not include a scored survey metric that matches the aggregate scored survey metric and all surveys that do not match the given date/date range. Next, the system provides users with user-determined filtering to further define the focus/purpose of the segment analysis beyond just a particular aggregate scored survey metric. For example, the company may only be interested in surveys completed by women or in surveys where the end-user was attempting to purchase a product. The user-determined filtering allows users to select which segments must be present in the survey data for consideration in the segment analysis. The system removes from consideration all surveys not pertaining to the user-determined filtering. Once the system has eliminated all extraneous surveys from consideration, the system segments each question/response combinations across the pool of surveys to generate an influence score for each question/response combination.

Once influence scores are determined for each segment, the system identifies which segment has the greatest positive and negative influence on the aggregate scored survey metric for the given date/date range. While users will frequently be interested in segment analysis for detected anomalous aggregate scored survey metrics, the system can perform an analysis for any specific aggregate scored survey metric, for example, customer satisfaction score and a specific date/date range. The system generates reports for the segment analysis. Additionally, the system stores all segment analyses for further comparative analysis, allowing the company to determine how influence may change over time.

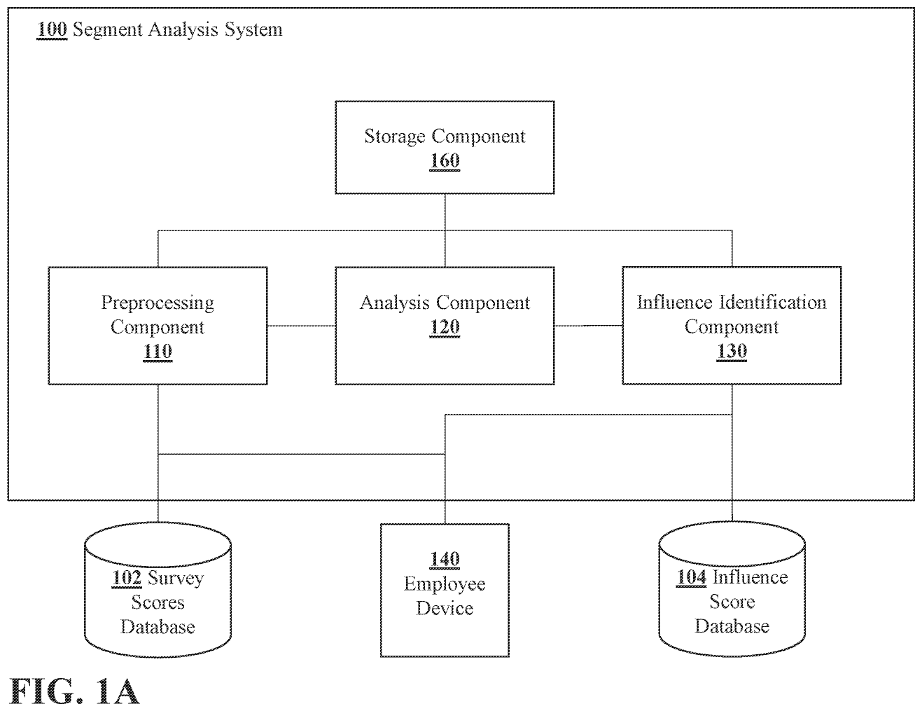

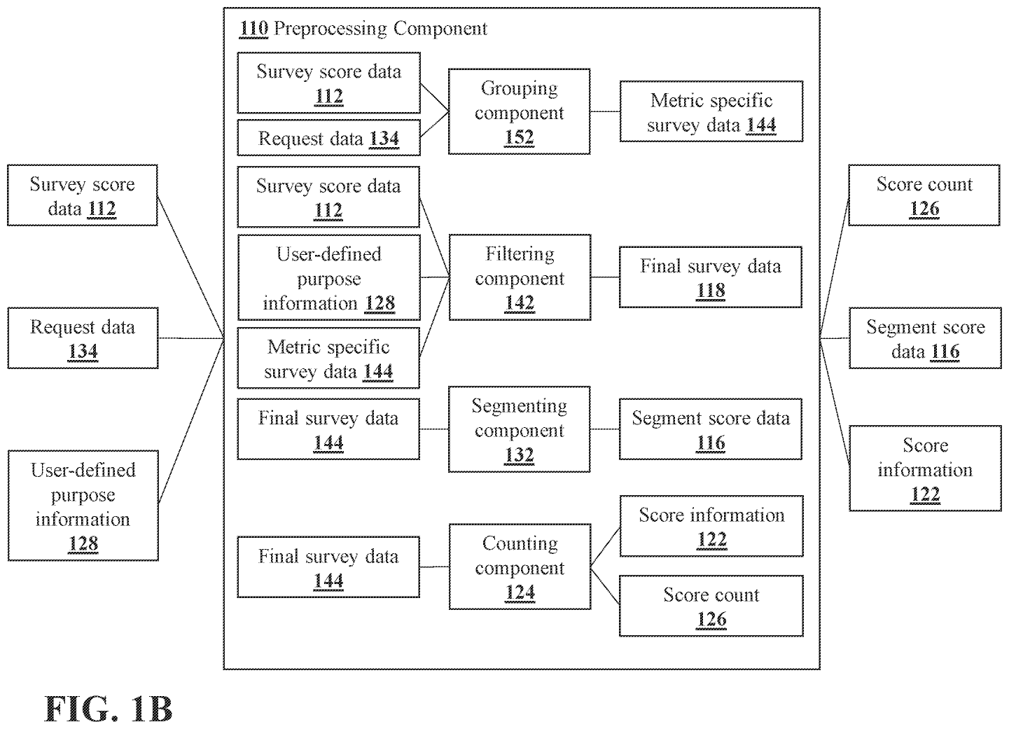

FIG. 1A depicts an example embodiment of a segment analysis system 100 with its components, services, and processes according to certain embodiments. FIG. 1B depicts an example of a preprocessing component 110 used in the segment analysis system 100, according to certain embodiments.

In an embodiment, the segment analysis system 100 may be part of a customer service center system (not shown) or may be a separate component integrated with the customer service center system or any other company system that stores survey data and/or metrics pertaining to survey data. The segment analysis system 100 interacts with a survey score database 102 to receive survey score data 112 for an aggregated scored survey metric and an influence score database 104 to store influence data. The segment analysis system 100 includes a preprocessing component 110 to prepare the survey score data 112 to generate segment score data 116, an analysis component 120 to generate influence scores for segment score data 116, and an influence identification component 130 to identify which segments have the greatest influence on the aggregate scored survey metric for the given date/date range and generate influence score reports and store influence data. Each of these components will be described in greater detail below. Employees of companies utilizing the system (hereinafter users) may interact with the segment analysis system 100. The segment analysis system 100 optionally includes one or more employee devices 140 useable by users for interacting with the segment analysis system 100 and for viewing influence score reports and influence data.

Survey score data 112 is all of the different survey data for each survey received by the company, including, but not limited to, each question/response pair for all questions, a date the survey is received by the system, and scored survey metrics. In an embodiment, the survey score data 112 is stored on a per survey basis and categorized based on each scored survey metric generated for each survey. In an embodiment, each survey score data 112 may be represented as a survey score data structure including fields for all associated information. In an embodiment, each survey score data 112 may be represented as an object, including attributes for all associated information. It should be understood that these are merely examples and that any appropriate structure for associating the numerical score and related information may be used. Scored survey metrics are different categories represented in customer survey responses to questions on customer surveys that a company may want to score. As a non-limiting example, the different scored survey metrics may be that of a customer satisfaction score, a score indicating how likely a customer will recommend a product or service, a score indicating a customer's opinion on the look and feel of the user experience, a score indicating ease of order processing and/or site performance, how likely the customer is to make further purchases, etc.

While each survey includes one or more different scored survey metrics, the customer service center system or any other company system that stores survey data and/or metrics pertaining to survey data also generates aggregate scored survey metrics for different durations. In an embodiment, an aggregate scored survey metric is an average of all survey scores for the associated scored survey metric based on a given date/date range. In other words, the aggregate scored survey metric for a daily duration for the customer satisfaction scored survey metric is the average score for all surveys received with a customer satisfaction scored survey metric for a particular day, according to certain embodiments. In other embodiments, other statistical methods may be employed for representations of an aggregate scored survey metric, such as a median, a floor, a ceiling, and more complex representations such as using a time series, vectors, matrices, formulaic expressions, or other representations. As another non-limiting example, the aggregate scored survey metric for a weekly duration for the customer satisfaction scored survey metric is the average of the scores for all surveys received for that metric for a particular week. Each aggregate scored survey metric will include, but not be limited to, a numerical score, an associated scored survey metric type, and an associated date/date range for the numerical score.

In an embodiment, survey score data 112 and aggregate scored survey metrics are stored by the customer service center system in the survey scores database 102. In an embodiment, survey score data 112 and aggregate scored survey metrics may be stored by the customer service center system in any appropriate media storage.

The segment analysis system 100 includes a preprocessing component 110 to receive survey score data 112 from the survey scores database 102. The preprocessing component 110 performs multiple processing procedures, described further below, on the survey score data 112 to generate segment score data 116 for creating influence data. In an embodiment, the preprocessing component 110 may be a processor or a combination of a processing system and a storage system with a preprocessing software component and optional preprocessing storage.

The preprocessing component 110 processes survey score data 112 to generate segment score data 116 for providing to the analysis component 120 to create influence data. Influence data is created for a given aggregate scored survey metric and a specified date/date range. In an embodiment, the customer service center system and/or the segment analysis system 100 provides a request in the form of request data 134 to the preprocessing component 110 to generate segment score data 116 to create influence data for the given aggregate scored survey metric. The request data includes, but is not limited to, a specific aggregate scored survey metric and a given date/date range. In an embodiment, the request is generated based any one of a user requesting influence data for a particular given aggregate scored survey metric, the system automatedly requesting influence data for a particular given aggregate scored survey metric, and/or rules governing the automated generation of influence data for a particular given scored survey metric. As non-limiting examples, some rules may be based on the time elapsed since influence data was last generated for a given aggregate scored survey metric, whether an anomaly was detected for a particular given aggregate scored survey metric for a particular date/date range, etc. For example, a rule might indicate that influence data should be generated for a given aggregate scored survey metric once every week or once every day. As another example, a rule might indicate that influence data should be generated for a given aggregate scored survey metric whenever an anomaly is detected for an aggregate scored survey metric. Over time, the segment analysis system 100 or the customer service center system may learn machine learning techniques and update the rules governing the automated generation of influence data for a particular given scored survey metric based on analysis of user requests for influence data creation.

In an embodiment, the preprocessing component 110 requests survey score data 112 from the survey scores database 102 based on the request data 134 from the user/system for the generation of influence score data for an aggregate scored survey metric for a specified date/date range. In an embodiment, the preprocessing component 110 may query the survey scores database 102 to receive a batch of survey score data 112 only, including surveys for the specified date/date range and for the aggregate scored survey metric such that the only survey score data received are surveys with a scored survey metric matching the aggregate scored survey metric with received dates within the specified date/date range. In an embodiment, the preprocessing component 110 may query the survey scores database 102 to receive a batch of survey score data 112 based on survey dates/date ranges, scored data metrics, or any combination of survey score data 112 that may be queried. In an embodiment, the preprocessing component 110 receives survey score data 112 for a plurality of aggregate scored survey metrics and specified dates/date ranges.

Segment score data 116 is created from survey score data 112. Segment score data 116 is survey score data 112 that is processed by the preprocessing component 110 to be in the format required for the analysis component 120 to generate influence data. Each segment score data 116 includes a question/response combination, a custom question on a survey, and the score for the scored survey metric on the survey matching the specific aggregate scored survey metric. In an embodiment, each segment score data 116 may be represented as a segment score data structure including fields for all associated information. In an embodiment, each segment score data 116 may be represented as an object, including attributes for all associated information. It should be understood that these are merely examples and that any appropriate structure for associating the question/response combination with the associated scored survey metric for the survey may be used.

In embodiments where the preprocessing component 110 receives survey score data 112 for a plurality of aggregate scored survey metrics and a plurality of specified dates/date ranges and/or in embodiments where the preprocessing component 110 receives survey score data 112 that includes any other survey data beyond that associated with the specific aggregate scored survey metric and the specific date/date range that influence data is requested for, the preprocessing component 110 uses a grouping component 152 to generate a set of metric-specific survey score data 144. The set of metric-specific survey score data 144 is survey score data 112 that only includes a scored survey metric matching the specific aggregate scored survey metric and the specified date/date range for the requested influence data.

In embodiments where influence data is requested for more than one aggregate scored survey metric and/or more than one specific date/date range, the grouping component 152 generates a set of metric-specific survey score data 144 for each aggregate scored survey metric and date/date range combination requested. As a non-limiting example, if the request data 134 for influence data is customer satisfaction scored survey metric on a specific date and for customer satisfaction scored survey metric on a different specific date range, the grouping component 152 will create a set of metric-specific survey score data 144 for the first request data 134 from the survey score data 112 received that includes only survey score data 112 that includes a scored survey metric for customer satisfaction that matches the specific date requested. The grouping component 152 also will create a second set of metric-specific survey score data 144 for the second request data 134 from the survey score data 112 received that includes only survey score data 112 with a scored survey metric for customer satisfaction that matches the specific date range requested.

The grouping component 152 analyzes all received survey score data 112 and removes any data points from the survey score data 112 that do not include a scored survey metric matching the requested aggregate scored survey metric and specific date/date range. Further, if more than one influence data generation is requested, the grouping component 152 will separate the survey score data 112 into different sets of metric-specific survey score data 144 one for each request data 134 such that each set of metric-specific survey score data 144 only includes the survey score data 112 with a scored survey metric and date/date range matching the request data 134. In embodiments where the preprocessing component queries the survey scores database 102 for only the survey score data 112 with a scored survey metric for the date/date range matching the requested aggregate scored survey metric and date/date range, it should be understood that the processing performed by the grouping component 152 may not be needed. In other words, the grouping component 152 removes all surveys from the receives survey score data 112 that do not include the aggregate scored survey metric and the given date/date range from consideration in the generation of influence data.

Each metric-specific survey score data 144 includes all of the same data as the corresponding survey score data 112. In other words, each metric-specific survey score data 144 includes all of the survey data for the specific survey associated with the specific survey score data 112. This includes, but is not limited to, each question/response pair for all questions, a date the survey was received by the system, and associated scored survey metrics for the survey. In an embodiment, each metric-specific survey score data 144 may be represented as a metric-specific score data structure including fields for all associated information. In an embodiment, each metric-specific survey score data 144 may be represented as an object, including attributes for all associated information. It should be understood that these are merely examples and that any appropriate structure for associating the survey and related information may be used.

The preprocessing component 110 uses a filtering component 142 to allow users to more specifically structure the surveys considered when generating influence data. The filtering component 142 receives user-defined purpose information that further restricts the surveys the system considers when generating influence data. In embodiments, users may only be interested in particular surveys for the given aggregate scored survey metric and given date/date range. The filtering component 142 allows users to generate influence data based on only the surveys, including questions directed to the purpose the user is interested in. As a non-limiting example, a user may only want influence data for surveys that have a customer satisfaction scored metric and where end-users were looking to purchase a product, or where the end-users are from Michigan, or where the end-users are female, etc. Considering surveys that do not match the user's purpose information may lead to misleading/inaccurate influence data. For example, if the user's purpose was to identify the question/response combinations that most influenced end-user's satisfaction with the purchasing process, also considering surveys with customer satisfaction scores where the end-suer was concerned with the look and feel of the website may not be beneficial to consider for the influence scores and may even give the user a misleading score.

The filtering component 142 allows users to filter a set of metric-specific survey score data 144 and/or a set of survey score data 112 based on user-defined purpose information. In an embodiment, the user-defined purpose information includes specifying which custom question(s) and/or custom question/response combination(s) are contained in the surveys that the user is interested in generating influence data on. As discussed above, surveys are generally made up of several types of questions, including but not limited to model questions/scored questions, custom questions, and free response questions. Custom questions are all questions on a survey that have yes/no and or provided multiple choice responses (e.g., question asking to pick from a given list a state of residence, question asking to pick from provided options the purpose for calling customer service, etc.) which are generally demographic type questions or purpose type questions. In an embodiment, surveys may have a categorization component that is associated with each survey indicating the type of purpose for the survey. In that embodiment, the user-defined purpose information may include selecting the purpose category the user is interested in generating influence data on. It should be understood that these are merely examples of what might be considered user-defined purpose information and that any field associated with a survey may be used to allow a user to further restrict the surveys that are considered in the generation of influence data and be considered user-defined purpose information.

The filtering component 142 analyzes the set of metric-specific survey score data 144 and/or a set of survey score data 112 to generate a set of final survey data 118 by removing any metric-specific survey score data 144 and any survey score data 112 that does not include the received user-defined purpose information. In embodiments, this means the filtering component 142 removes all surveys that do not include the custom question(s) or custom question/response combination(s) identified by the user as user-defined purpose information. In other words, the filtering component removes all surveys from the received set of metric-specific survey score data 144 or survey score data 112 (if the grouping component processing was not used) that do not include as one of the custom questions or custom question/response combinations the custom questions or custom question/response combinations indicated by the user. The remaining surveys make up the set of final survey data 118.

Each final survey data 118 includes all of the same data as the corresponding metric-specific survey score data 144 or the corresponding survey score data 112. In other words, each final survey data 118 making up the set of final survey data 118 includes all of the survey data for the specific survey associated with the specific metric-specific survey score data 144 or specific survey score data 112. This includes, but is not limited to, each question/response pair for all questions, a date the survey was received by the system, and associated scored survey metrics for the survey. In an embodiment, each final survey data 118 may be represented as a final score data structure, including fields for all associated information. In an embodiment, each final survey data 118 may be represented as an object, including attributes for all associated information. It should be understood that these are merely examples and that any appropriate structure for associating the survey and related information may be used.

After processing by the grouping component 152 and the filtering component 142, the received survey score data 112 has been paired down to a set of final survey data 118, which only includes surveys having the custom question(s)/custom question/response combinations specified by the user and having a scored survey metric and date/date range matching the specified aggregate scored survey metric and specified date/date range. These components allow the user to customize and specify the surveys that are considered by the system when generating influence data. This customization provides the user with more accurate and detailed influence data and allows the user greater granularity when analyzing the influence of question/response combinations on aggregate scored survey metrics.

Once the final survey data 118 is generated, the preprocessing component 110 may use a counting component 124 to generate score information 122 and a survey count 126 for the final survey data 118. In an embodiment, score information 122 includes the score for the scored survey metric corresponding to the aggregate scored survey metric for each survey in the final survey data 118. For example, if the aggregate scored survey metric is that of customer satisfaction, the score information 122 will include the customer satisfaction score for each individual survey in the final survey data 118. In an embodiment, the score information 122 may be a listing of each score for each survey kept in any data structure appropriate to the use case, for example, but not limited to an array, a list, a dictionary, or a hash table. The survey count 126 is the number of surveys included in the final survey data 118.

The counting component 124 analyzes each of the surveys in the final survey data 118 and extracts the scored survey metric matching the aggregate scored survey metric for the requested influence data and stores it as score information 122. While extracting the score information 122 from each survey, the counting component 124 also determines the number of surveys in the final survey data 118 and stores the total as the survey count.

The preprocessing component 110 further utilizes a segmenting component 132 to generate segment score data 116 from the final survey data 118. The segmenting component 132 analyzes the custom question/response combinations for each survey in the final survey data 118 and groups the score for the scored survey metric matching the aggregate scored survey metric for each survey having the same custom question/response combination into a segment score data 116. In other words, each segment score data 116 includes the score for the scored survey metric of each survey that includes the same custom question/response combination. Therefore, there will be one segment score data 116 for each custom question/response combination present in the final survey data 118.

As a non-limiting example, consider a survey with one custom question that has response values of yes/no and ten responses to the survey. The pool of responses to the survey includes two custom question/response combinations, that of the custom question with an affirmative (yes) response and that of the custom question with a negative (no) response. If six of the survey responses have an affirmative (yes) response and four of the survey responses have a negative (no) response, the segmenting component 132 will generate one segment score data 116 made up of the six scores for the scored survey metric from the six affirmative responses and a second segment score data 116 made up of the four scores for the scored survey metric from the four negative responses.

Each segment score data 116 may be any data structure appropriate to the use case, for example, but not limited to an array, a list, a dictionary, a hash table, etc. Each segment score data 116 is associated with the custom question/response combination the scores contained in it represent. It should be understood that the above is one of the simplest examples of custom question/response combinations being segmented into segment score data 116 and that as the number of custom questions and number of available responses to the custom questions increases across the set of final survey data 118 the greater the number of segment score data 116 are generated by the segmenting component 132. By segmenting the scores associated with each custom question/response combination, the segment analysis system 100 can determine the influence each custom question/response combination has on the aggregate scored survey metric for the set of final survey data 118.

The segment analysis system 100 further incudes an analysis component 120 to generate influence data based on a request for influence data. As indicated above, request data 134 for influence data includes a specific aggregate scored survey metric and a given date/date range, which can be further focused based on the received user-defined purpose information. For each request for influence data, the analysis component 120 receives all of the generated segment score data 116, the score information 122, and the survey count 126 from the preprocessing component. The analysis component 120 generates influence data for each generated segment score data 116 received. In an embodiment, the influence data is a standardized positive or negative score centered around 0, indicating the degree of positive influence or negative influence the particular segment score data 116 has on the aggregate scored survey metric. The closer the number is to 0, the smaller the influence, the further from 0 in either the negative or positive direction, the greater the influence. The standardization of the score across all segment score data 116 (custom question/response segments) allows the influence identification component 130 to perform cross-question/response combination comparisons to determine which question/response combinations have the greatest influence on the aggregate scored survey metric for the given date/date range. Each influence data is associated with the respective segment score data 116 (question/response combination) from which it was generated, and the associated aggregate scored survey metric and given date/date range from which the segment score data 116 was generated. In an embodiment, the association may be created by binding and unbinding operations for each of the respective data structures. In an embodiment, the association may be created by the influence data being an influence data structure with fields for each the influence score, the associated segment score data 116, the associated aggregate scored survey metric, the score for the associated aggregate scored survey metric, and the given date/date range for the associated scored survey metric. In an embodiment, influence data may be represented as an object, including attributes for all associated information. It should be understood that these are merely examples and that any appropriate structure for associating the influence data, segment score data 116, aggregate scored survey metric, and given data/date range for the scored survey metric may be used.

In an embodiment, the analysis component 120 calculates the mean and standard deviation for the population of final survey data 118 using the score information 122 and the survey count 126. This generates the mean and standard deviation for all surveys to be considered when generating the requested influence data. As explained above, this includes only surveys including the received user-defined purpose information and with scored survey metrics matching the given aggregate scored survey metric and the given date/date range. As a non-limiting example, if there were ten surveys in the final survey data 118 (meaning the survey count 126 is 10) and the scores for the scored survey metric matching the given aggregate scored survey metric for each survey are {78, 65, 91, 85, 89, 67, 92, 81, 90, 91}, the mean is 82.9, and the standard deviation is 9.52.

Next, in an embodiment, for each segment score data 116 (each question/response combination), the analysis component 120 calculates the mean for the segment score data 116. As a continuing non-limiting example using the ten surveys indicated above, if 5 of those surveys include the question/response pair “Task accomplished/No,” and the scores for the scored survey metric match the aggregate scored survey metric for those five surveys are {65, 67, 78, 81, 85}, the mean for the segment score data 116 is 75.2.

In an embodiment, based on the mean and standard deviation generated for the final survey data 118 and the mean generated for a segment score data 116, the analysis component 120 generates influence data for the segment score data 116 (question/response pair). The analysis component 120 generates influence data for each segment score data 116.

In an embodiment, the analysis component 120 uses the following calculation in the generation of the influence data; where influence data is generated for each individual segment score data 116 (j), from j=1 to j=J, there being J total individual segment score data 116 for which to generate influence data:

$${S}_{j} = \frac{( \frac{{\overline{x}}_{j} - \overline{x}}{{σ}_{x}} ) {n}_{j}}{n}$$

where x̅ⱼ=the mean of the segment score data 116 in the jth segment (i.e., the mean of the scores with surveys including the question/response combination); x̅=the mean of the scores for the final survey data 118 (i.e., the mean of the score information 122); σₓ=the standard deviation of the scores for the final survey data 118 (i.e., the standard deviation for the score information 122); nⱼ=the number of scores in the segment score data 116 in the jth segment; and nⱼ=the number of surveys in the final survey data 118 (i.e., the survey count 126).

The analysis component 120 generates influence data for each of the segment score data 116. In the embodiment using the above calculation, the influence data is a numerical score centered around 0, where the more positive the score, the greater the positive impact of the segment score data 116 on the aggregate survey score metric, and the more negative the score, the greater the negative impact of the segment score data 116 on the aggregate survey score metric. Continuing the non-limited example above, the numerical score generated for the influence data is −0.404 for that particular segment score data 116 (question/response combination). Whether this segment score data 116 is considered to have a substantial impact on the aggregate scored survey metric will depend on the rest of the influence data generated for the remaining segment score data 116. However, in this embodiment, on its own, without any other generated influence data, it can be determined whether the segment score data 116 (question/response combination) has a positive or negative impact on the aggregate scored survey metric. In this embodiment, positive influence data indicates a positive impact on the aggregate scored survey metric, and negative influence data indicates a negative impact on the aggregate scored survey metric.

Once the influence data is generated for each of the segment score data 116, the segment analysis system 100 uses an influence identification component 130 to analyze the influence data and generate influence score reports and update the influence score database 104. The influence identification component 130 receives the influence data for the aggregate scored survey metric from the analysis component 120. The influence identification component 130 compares all of the scores for the influence data and orders the influence data in numerical order based on the influence data score. The segment score data 116 (question/response combination) associated with the largest influence data scores have the greatest positive influence on the associated scored survey metric and given date/date range. The segment score data 116 (question/response combination) associated with the smallest (in some embodiments the most negative) influence data scores have the greatest negative influence on the associated scored survey metric and given date/date range.

The influence identification component 130 generates an influence score report 108 and updates the influence score database 104. In an embodiment, the update to the influence score database 104 includes all generated influence data and associated information, such as but not limited to, the associated segment score data 116, the associated aggregate scored survey metric, and the given date/date range associated with the aggregate scored survey metric. In an embodiment, the influence score report 108 all generated influence data and associated information, such as but not limited to, the associated segment score data 116, the associated aggregate scored survey metric, and the given date/date range associated with the aggregate scored survey metric. In an embodiment, the influence identification component 130 identifies a predetermined number of influence data with the most influence on the aggregate scored survey metric to include in the influence score report 108. As a non-limiting example, the influence score report 108 includes the influence score data for the three most positive influence data scores and the three most negative influence data scores. In an embodiment, where the influence data is requested due to an anomalous aggregate scored survey metric, the user may only be interested in influence data having the greatest influence on the anomaly; the influence score report 108 includes only the top three positive or negative influence data scores depending on whether the anomaly was a positive or negative anomaly. For example, if the anomaly was a negative anomaly, the influence score report may include the influence data for the three most negative influence data scores as those segment score data 116 (question/response combinations) had the greatest influence on making the anomaly negative. The same would hold true for a positive anomaly, but the influence score report 108 would include influence data from the three most positive influence data scores. It should be understood that the predefined number three is merely an example of the number of influence data to be included in the report, and the number could be any number that provides the user with a paired down number of results.

The survey score data 112, segment score data 116, final survey data 118, score information 122, survey count 126, metric-specific survey score data 144, influence data, influence data score, scored survey metric, aggregate scored survey metric, given date/date range, and user-defined purpose information may be stored in a storage component 160 for later use.

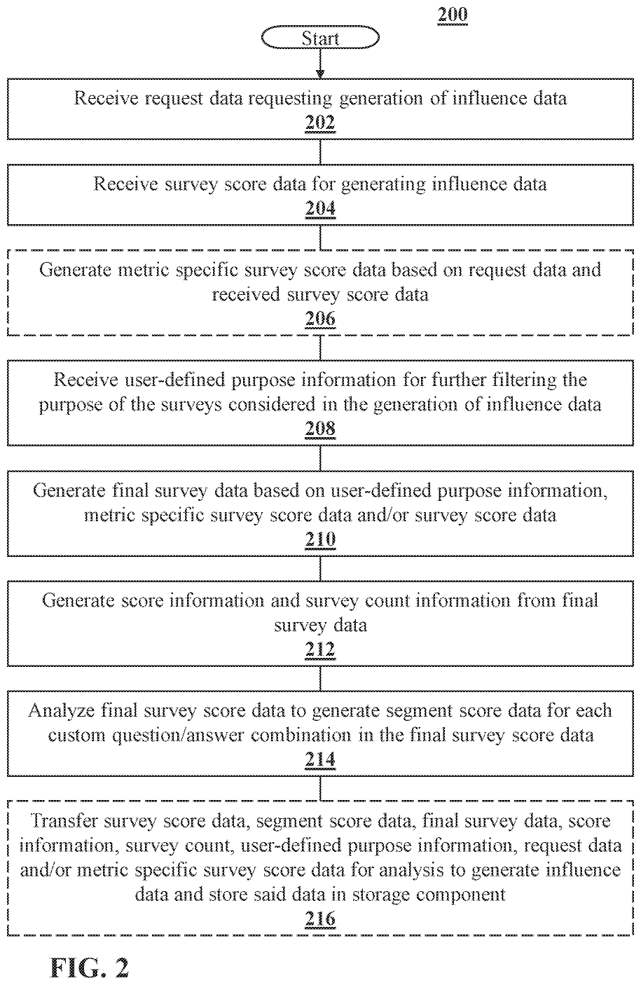

FIG. 2 depicts an example flow diagram of a method 200 for preparing survey score data 112 to generate influence data according to certain embodiments. The numbering and sequencing of the blocks are for reference only; blocks or sequences of blocks may be performed out of order or repeated.

As discussed above, the influence data provides an influence score for each question/response combination in a set of surveys that make up a specific aggregate scored survey metric for a given date/date range. Influence data can be generated for any specific aggregate scored survey metric and given date/date range.

At block 202, the segment analysis system 100 at the preprocessing component 110 receives a request for the generation of influence data for a specific aggregate scored survey metric and a given date/date range, represented as request data 134. As indicated above, the request may be automatically generated by the segment analysis system 100, any system connected/integrated with the segment analysis system 100, or may be manually generated by users of the system. In embodiments, the preprocessing component 110 receives multiple requests for the generation of influence data at the same time or near simultaneously. In embodiments, the request may include a plurality of specific aggregate scored survey metrics, each with a given date/date range.

At block 204, survey score data 112 is received by the preprocessing component 110 based on the request. Survey score data 112 is used to generate segment score data 116, score information 122, and survey count 126, which is used to generate influence data. The survey score data 112 may be for any aggregate scored survey metric and date/date range. In an embodiment, the received survey score data 112 received is survey score data 112 specific to the specific aggregate scored survey metric and the given date/date range for the request. In embodiments, with multiple simultaneous requests or with a request that includes more than one aggregate scored survey metric and date/date ranges in the request, the preprocessing component 110 may receive all of the applicable survey score data 112 at the same time. In embodiments, the preprocessing component 110 may receive additional survey score data 112 not applicable to the aggregate scored survey metric(s) and given date(s)/date range(s) that are part of the request.

At optional block 206, metric specific survey score data 144 is generated from survey score data 112 by the preprocessing component 110 using a grouping component 152. The grouping component analyzes the survey score data 112 and removes all survey score data 112 that does not match the request data 134 (the specified scored survey metric(s) and date(s)/date range(s)) for the requested influence data. Once the extra survey score data 112 is removed, the grouping component 152 generates a set of metric-specific survey score data 144 for each of the requested specific aggregate scored survey metrics and given date/date range by grouping the survey score data 112 into the corresponding set of metric-specific survey score data 144 that matches the request. It should be understood that if the survey score data 112 received is for a single aggregate scored survey metric and date/date range request that block 206 may be skipped.

At block 208, the preprocessing component 110, using a filtering component 142, receives user-defined purpose information 128. User-defined purpose information 128 allows the user to further specify and filter the surveys considered when generating influence data by further restricting the surveys in the sets of metric-specific survey score data 144 and survey score data 112. In embodiments, users may only be interested in particular purposes of surveys for the given aggregate scored survey metric and given date/date range. In an embodiment, the user-defined purpose information includes specifying which custom question(s) and/or custom question/response combination(s) are contained in the surveys that the user is interested in generating influence data on. Custom questions are all questions on a survey that have yes/no and or provided multiple choice responses (e.g., question asking to pick from a given list a state of residence, question asking to pick from provided options the purpose for calling customer service, etc.) which are generally demographic type questions or purpose type questions. In an embodiment, surveys may have a categorization component that is associated with each survey indicating the type of purpose for the survey. In that embodiment, the user-defined purpose information may include selecting the purpose category the user is interested in generating influence data on. It should be understood that these are merely examples of what might be considered user-defined purpose information and that any field associated with a survey may be used to allow a user to further restrict the surveys that are considered in the generation of influence data and be considered user-defined purpose information.

At block 210, the filtering component 142 analyzes the set of metric-specific survey score data 144 and set of survey score data 112 (for an influence data request) based on the received user-defined purpose information 128 to generate a set of final survey data 118. The filtering component removes any surveys from the metric-specific survey score data 144 and survey score data 112 that do not include the received user-defined purpose information 128. The remaining surveys make up the set of final survey data 118 and include only surveys that match the user-defined purpose information 128 and the specific aggregate scored survey metric and given date/date range.

At block 212, the preprocessing component 110 uses a counting component 124 to analyze the set of final survey data 118 to generate score information 122 and a survey count. The counting component 124 analyzes each survey in the set of final survey data 118 and stores the score for the scored survey metric from each survey matching the specific aggregate scored survey metric as score information 122. The score information may be represented as any appropriate data structure for storing the scores from a set of scored survey metrics, including, but not limited to, a list, an array, a hash table, etc. In addition, the counting component 124 counts the number of surveys included in the set of final survey data 118 to generate a survey count 126.

At block 214, segment score data 116 is generated from the set of final survey data 118 by the preprocessing component 110 using a segmenting component 132. The segmenting component 132 analyzes the custom question/response combinations for each survey in the final survey data 118 and groups the score for the scored survey metric matching the aggregate scored survey metric for each survey having the same custom question/response combination into a segment score data 116. In other words, each segment score data 116 includes the score for the scored survey metric of each survey that includes the same custom question/response combination. Therefore, there will be one segment score data 116 for each custom question/response combination present in the final survey data 118. Each segment score data 116 may be any data structure appropriate to the use case, for example, but not limited to an array, a list, a dictionary, a hash table, etc. Each segment score data 116 is associated with the custom question/response combination the scores contained in it represent. By segmenting the scores associated with each custom question/response combination, the segment analysis system 100 can determine the influence each custom question/response combination has on the aggregate scored survey metric for the set of final survey data 118.

At block 216, the preprocessing component 110 optionally stores the received survey score data 112, segment score data 116, final survey data 118, score information 122, survey count 126, user-defined purpose information 128, request data 134, and/or metric-specific survey score data 144 to a storage component 160 or any other storage on the system for later use or for a later generation of influence data. The preprocessing component 110 also optionally transfers the segment score data 116, the score information 122, and the survey count 126 to an analysis component 120 for the generation of influence data.

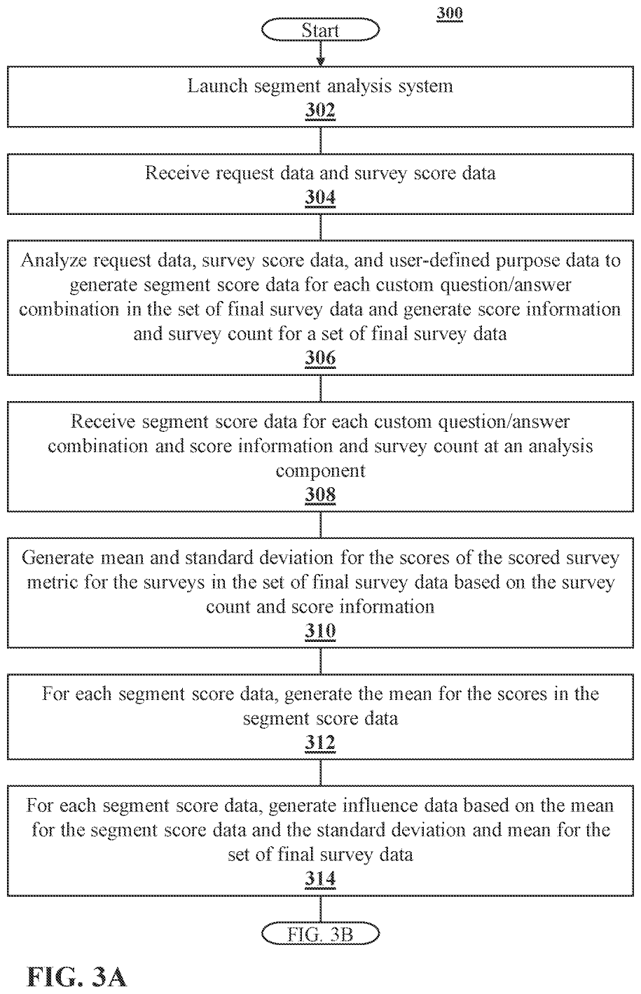

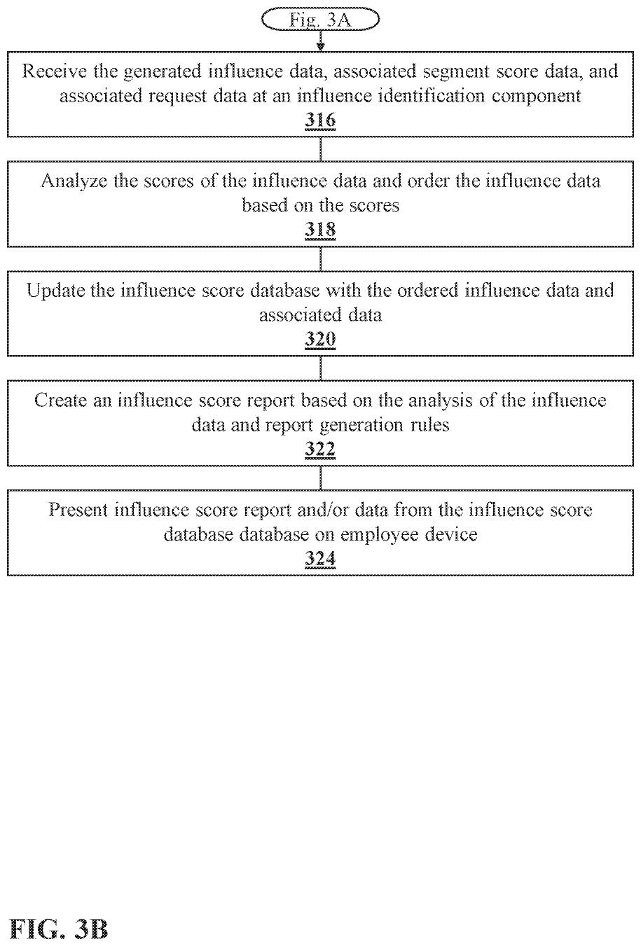

FIGS. 3A and 3B depict an example flow diagram of operations performed by the segment analysis system 100 according to certain embodiments. The numbering and sequencing of the blocks are for reference only; blocks or sequences of blocks may be performed out of order or repeated.

At block 302, the segment analysis system 100 is launched to generate influence data for an aggregate scored survey metric and given data/date range. The generation of influence data may occur automatically (e.g., daily, weekly, monthly, every time new aggregate scored survey metrics are added to the survey scores database 102, every time a new anomaly is detected for an aggregate scored survey metric or on any other basis that a company may want to schedule influence data determinations or may be manually requested by users of the system.

At block 304, the segment analysis system 100 at the preprocessing component 110 receives a request for the generation of influence data for a specific aggregate scored survey metric and a given date/date range, represented as request data 134, and receives survey score data 112. As indicated in block 204 from FIG. 2, the request may be more than one request received simultaneously, and/or the request may include more than one specific aggregate scored survey metric and given date/date range.

At block 306, segment score data 116, score information 122, and survey count 126 are generated from the survey score data 112 and user-defined purpose information 128 by the preprocessing component 110. The methods from blocks 204 through 214 from FIG. 2 are used to generate the segment score data 116, score information 122, and survey count 126.

At block 308, the analysis component 120 receives the segment score data 116, score information 122, and survey count 126 from the preprocessing component 110.

At block 310, the analysis component 120 generates the mean and standard deviation for the population of the set of final survey data 118 using the score information 122 and the survey count 126. This generates the mean and standard deviation for all surveys to be considered when generating the requested influence data. As explained above, this includes only surveys including the received user-defined purpose information and with scored survey metrics matching the given aggregate scored survey metric and the given date/date range.

At block 312, for each segment score data 116 (each question/response combination) received for the specific aggregate scored survey metric and given date/date range, the analysis component 120 calculates the mean for the scores in the segment score data 116.

At block 314, influence data is generated by the analysis component 120 for each segment score data 116 based on the mean and standard deviation generated for the final survey data 118 and the mean generated for a segment score data 116. Each generated influence data is associated with the respective segment score data 116 (question/response combination) from which it was generated and the associated request data 134 (aggregate scored survey metric and given date/date range) from which the segment score data 116 was generated. In an embodiment, the analysis component 120 uses the following calculation in the generation of the influence data; where influence data is generated for each individual segment score data 116 (j), from j=1 to j=J, there being J total individual segment score data 116 for which to generate influence data:

$${S}_{j} = \frac{( \frac{{\overline{x}}_{j} - \overline{x}}{{σ}_{x}} ) {n}_{j}}{n}$$

where x̅ⱼ=the mean of the segment score data 116 in the jth segment (i.e., the mean of the scores with surveys including the question/response combination); x̅=the mean of the scores for the final survey data 118 (i.e., the mean of the score information 122); σₓ=the standard deviation of the scores for the final survey data 118 (i.e., the standard deviation for the score information 122); nⱼ=the number of scores in the segment score data 116 in the jth segment; and n=the number of surveys in the final survey data 118 (i.e., the survey count 126). In the embodiment using the above calculation, the influence data is a numerical score centered around 0, where the more positive the score, the greater the positive impact of the segment score data 116 on the aggregate survey score metric, and the more negative the score, the greater the negative impact of the segment score data 116 on the aggregate survey score metric.

At block 316, receive, at an influence identification component 130, each generated influence data and the data associated with each influence data for request data 134 (the specific augmented scored survey metric and given date/date range) from the analysis component 120 for generation of influence score reports 108 and updating of the influence score database.

At block 318, the influence identification component 130 analyzes the influence data scores and puts the influence date in numerical order based on the influence data scores.

At block 320, the influence identification component 130 updates the influence score database with the ordered influence data. In an embodiment, the update to the influence score database 104 includes all generated influence data and associated information, such as but not limited to, the associated segment score data 116, the associated aggregate scored survey metric, and the given date/date range associated with the aggregate scored survey metric.

At block 322, an influence score report 108 is generated by the influence identification component 130 based on the influence data and the ordering of the influence data. The influence score report 108 may be generated automatedly based on a set of report generation rules or may be generated based on a user request. The report generation rules and/or user requests for report generation may provide influence score reports 108 in a variety of formats, including a variety of influence data information. In an embodiment, the influence score report 108 includes all generated influence data and associated information, such as but not limited to, the associated segment score data 116, the associated aggregate scored survey metric, and the given date/date range associated with the aggregate scored survey metric. In an embodiment, the influence identification component 130 identifies a predetermined number of influence data with the most influence on the aggregate scored survey metric to include in the influence score report 108.

At block 324, the influence score report 108 and/or the stored information in the influence score database 104 is presented on an employee device 140.

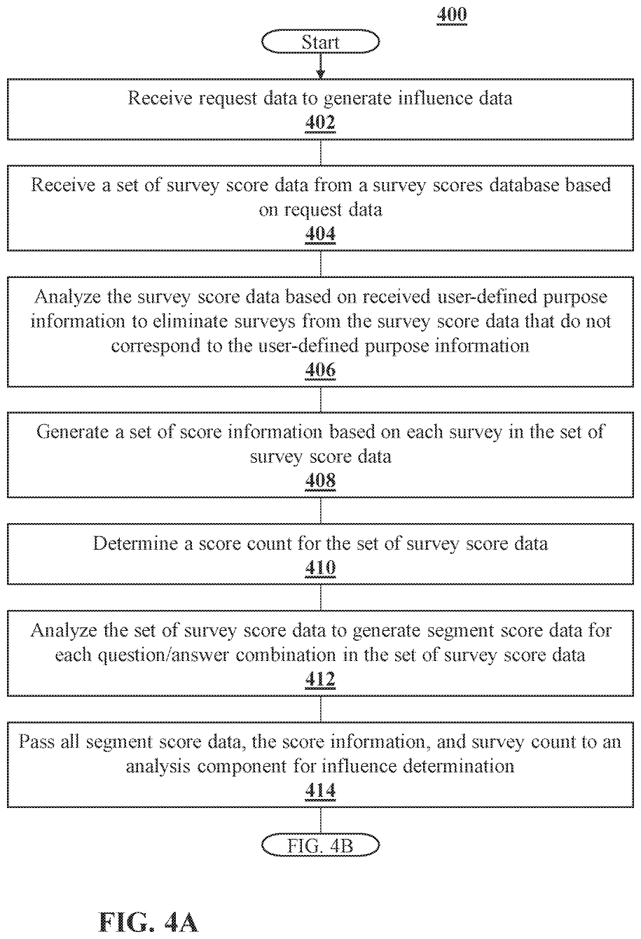

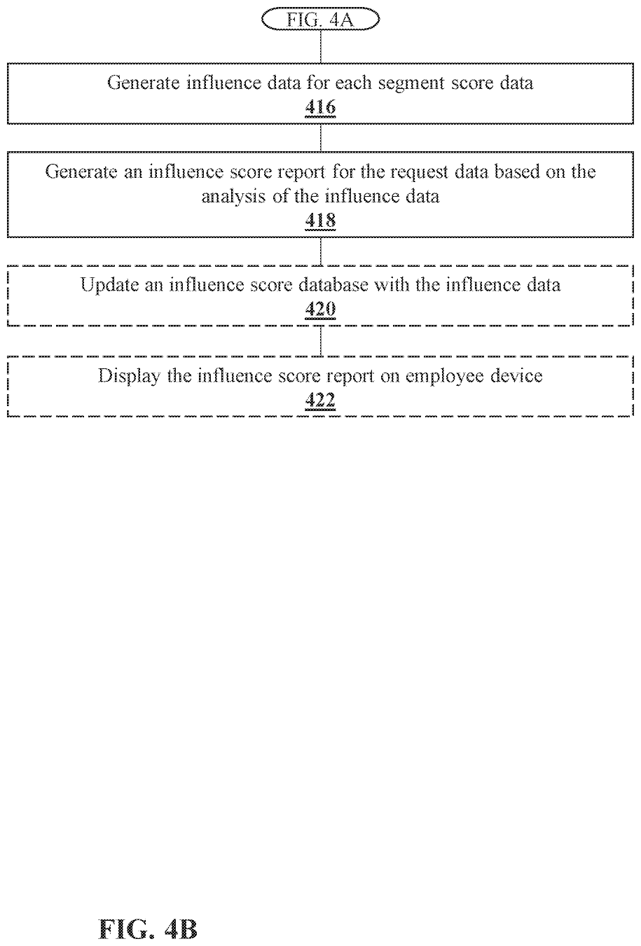

FIGS. 4A and 4B depict an example flow diagram of operations performed by the segment analysis system 100 according to certain embodiments. The numbering and sequencing of the blocks are for reference only; blocks or sequences of blocks may be performed out of order or repeated.

At block 402, the segment analysis system 100 at the preprocessing component 110 receives a request for the generation of influence data for a specific aggregate scored survey metric and a given date/date range, represented as request data 134. As indicated above, the request may be automatically generated by the segment analysis system 100, any system connected/integrated with the segment analysis system 100, or may be manually generated by users of the system. In embodiments, the preprocessing component 110 receives multiple requests for the generation of influence data at the same time or near simultaneously. In embodiments, the request may include a plurality of specific aggregate scored survey metrics, each with a given date/date range.

At block 404, survey score data 112 is received by the preprocessing component 110 based on the request data 134. Survey score data 112 is used to generate segment score data 116, score information 122, and survey count 126, which is used to generate influence data. The survey score data 112 may be for any aggregate scored survey metric and date/date range. In an embodiment, the received survey score data 112 received is survey score data 112 specific to the specific aggregate scored survey metric and the given date/date range for the request. In embodiments, with multiple simultaneous requests or with a request that includes more than one aggregate scored survey metric and date/date ranges in the request, the preprocessing component 110 may receive all of the applicable survey score data 112 at the same time. In embodiments, the preprocessing component 110 may receive additional survey score data 112 not applicable to the aggregate scored survey metric(s) and given date(s)/date range(s) that are part of the request.

At block 406, the preprocessing component 110 uses a filtering component 142 and optionally a grouping component 152 to analyze the survey score data 112 and remove any surveys from the survey score data 112. The surveys removed are those that do not correspond to received user-defined purpose information 128 and do not include a scored survey metric and date/date range that corresponds to the aggregate scored survey metric and given date/date range in the request data 134. In an embodiment, the set of survey score data 112 is simply updated by the removal. In an embodiment, the preprocessing component optionally uses the grouping component, and using the filtering component generates a set of final survey data 118 representing the survey score data 112 with the filtered surveys removed. The received user-defined purpose information 128 allows the user to further specify and filter the surveys considered when generating influence data by further restricting the surveys included in the survey score data 112 and/or final survey data 118. In embodiments, users may only be interested in particular purposes of surveys for the given aggregate scored survey metric and given date/date range. In an embodiment, the user-defined purpose information includes specifying which custom question(s) and/or custom question/response combination(s) are contained in the surveys that the user is interested in generating influence data on.

At block 408, the preprocessing component 110 uses a counting component 124 to generate a set of score information 122 based on the updated set of survey score data 112 or final survey data 118 (depending on the embodiment) from block 406. The counting component 124 analyzes each survey in the updated set of survey score data 112 or set of final survey data 118 to and stores the score for the scored survey metric from each survey matching the specific aggregate scored survey metric as score information 122. The score information may be represented as any appropriate data structure for storing the scores from a set of scored survey metrics, including, but not limited to, a list, an array, a hash table, etc.

At block 410, the preprocessing component 110 uses a counting component 124 to determine a survey count 126 of the surveys in the updated set of survey score data 112 or set of final survey data 118 (depending on the embodiment). The counting component 124 counts the number of surveys included in the updated set of survey score data 112 or set of final survey data 118 to generate a survey count 126.

At block 412, segment score data 116 is generated from the updated set of survey score data 112 or set of final survey data 118 by the preprocessing component 110 using a segmenting component 132. The segmenting component 132 analyzes the custom question/response combinations for each survey in the updated set of survey score data 112 or final survey data 118 and groups the score for the scored survey metric matching the aggregate scored survey metric for each survey having the same custom question/response combination into a segment score data 116. In other words, each segment score data 116 includes the score for the scored survey metric of each survey that includes the same custom question/response combination. Therefore, there will be one segment score data 116 for each custom question/response combination present in the updated set of survey score data 112 or final survey data 118. Each segment score data 116 may be any data structure appropriate to the use case, for example, but not limited to an array, a list, a dictionary, a hash table, etc. Each segment score data 116 is associated with the custom question/response combination the scores contained in it represent. By segmenting the scores associated with each custom question/response combination, the segment analysis system 100 can determine the influence each custom question/response combination has on the aggregate scored survey metric for the updated set of survey score data 112 or set of final survey data 118.

At block 414, the preprocessing component 110 passes all segment score data 116, score information 122, and survey count 126 to an analysis component 120 for the generation of influence data.

At block 416, the analysis component 120 generates influence data for each received segment score data 116 based on the score information 122, survey count 126. The influence data for each segment score data 116 includes an influence score for the question/response combination associated with the particular segment score data, the question/response combination associated with the particular segment score data, and the request data. In an embodiment, influence data is generated by the analysis component 120 for each segment score data 116 based on the mean and standard deviation generated for the updated set of survey score data 112 final survey data 118 using the score information 122 and survey count 126 and a mean generated for a particular segment score data 116. In an embodiment, the analysis component 120 uses the following calculation in the generation of the influence data; where influence data is generated for each individual segment score data 116 (j), from j=1 to j=J, there being J total individual segment score data 116 for which to generate influence data:

$${S}_{j} = \frac{( \frac{{\overline{x}}_{j} - \overline{x}}{{σ}_{x}} ) {n}_{j}}{n}$$

where x̅ⱼ=the mean of the segment score data 116 in the jth segment (i.e., the mean of the scores with surveys including the question/response combination); x̅=the mean of the scores for the final survey data 118 (i.e., the mean of the score information 122); σₓ=the standard deviation of the scores for the final survey data 118 (i.e., the standard deviation for the score information 122); nⱼ=the number of scores in the segment score data 116 in the jth segment; and n=the number of surveys in the final survey data 118 (i.e., the survey count 126). In the embodiment using the above calculation, the influence data is a numerical score centered around 0, where the more positive the score, the greater the positive impact of the segment score data 116 on the aggregate survey score metric, and the more negative the score, the greater the negative impact of the segment score data 116 on the aggregate survey score metric.

At block 418, an influence identification component 130 receives the influence data and generates an influence score report based on the analysis of the influence data. In an embodiment, the influence identification component 130 orders the influence data according to the influence scores. The influence score report 108 may be generated automatedly based on a set of report generation rules or may be generated based on a user request. The report generation rules and/or user requests for report generation may provide influence score reports 108 in a variety of formats, including a variety of influence data information. In an embodiment, the influence score report 108 includes all generated influence data and associated information, such as but not limited to, the associated segment score data 116, the associated aggregate scored survey metric, and the given date/date range associated with the aggregate scored survey metric. In an embodiment, the influence identification component 130 identifies a predetermined number of influence data with the most influence on the aggregate scored survey metric to include in the influence score report 108.

At optional block 420, the influence identification component 130 updates an influence score database 104 with the influence data.

At optional block 422, the influence identification component 130 presents the influence score report 108 and/or data in the influence score database 104 on an employee device 140.

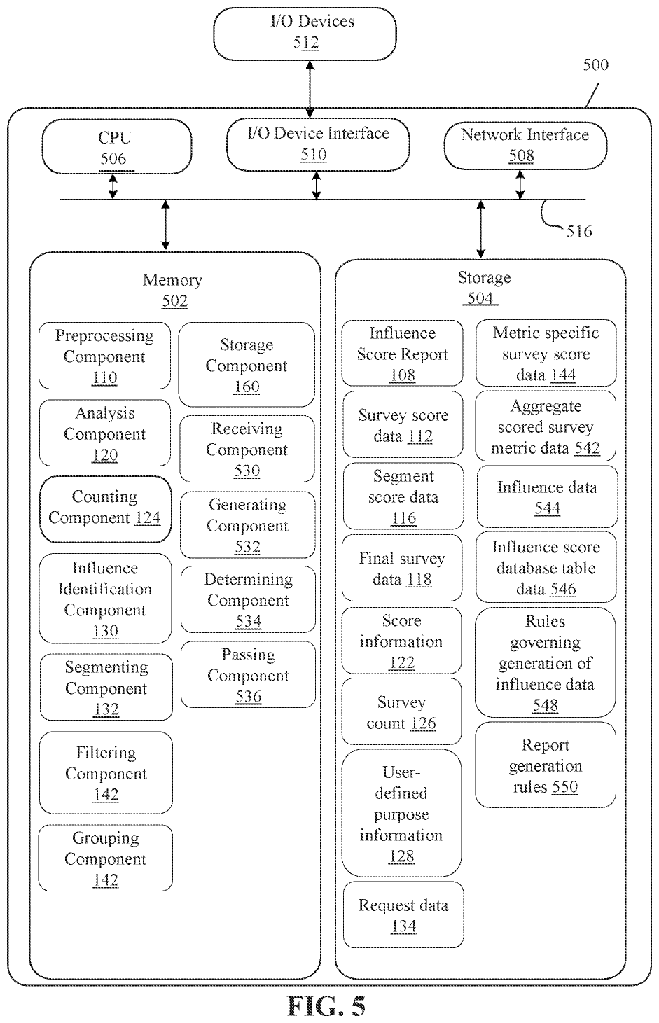

FIG. 5 depicts an example diagram of a computer system 500 that may include the kinds of software programs, data stores, hardware, and interfaces that can implement segment analysis system 100 as disclosed herein and according to certain embodiments. The computing system 500 may be used to implement embodiments of portions of the segment analysis system 100 or in carrying out embodiments of method 200, method 300 and/or method 400. The computing system 500 may be part of or connected to an overarching customer service center system.

As shown, the computer system 500 includes, without limitation, a memory 502, a storage 504, a central processing unit (CPU) 506, and a network interface 508, each connected to a bus 516. The computing system 500 may also include an input/output (I/O) device interface 510 connecting I/O devices 512 (e.g., keyboard, display, and mouse devices) and/or a network interface 508 to the computing system 500. Further, the computing elements shown in computer system 500 may correspond to a physical computing system (e.g., a system in a data center), a virtual computing instance executing within a computing cloud, and/or several physical computing systems located in several physical locations connected through any combination of networks and/or computing clouds.

Computing system 500 is a specialized system specifically designed to perform the steps and actions necessary to execute methods 200, 300, and 400 and segment analysis system 100. While some of the component options for computing system 500 may include components prevalent in other computing systems, computing system 500 is a specialized computing system specifically capable of performing the steps and processes described herein.

The CPU 506 retrieves, loads, and executes programming instructions stored in memory 502. The bus 516 is used to transmit programming instructions and application data between the CPU 506, I/O interface 510, network interface 508, and memory 502. Note, the CPU 506 can comprise a microprocessor and other circuitry that retrieves and executes programming instructions from memory 502. CPU 506 can be implemented within a single processing element (which may include multiple processing cores) but can also be distributed across multiple processing elements (with or without multiple processing cores) or sub-systems that cooperate in existing program instructions. Examples of CPUs 506 include central processing units, application-specific processors, and logic devices, as well as any other type of processing device, a combination of processing devices, or variations thereof. While there are a number of processing devices available to compromise the CPU 506, the processing devices used for the CPU 506 are particular to this system and are specifically capable of performing the processing necessary to execute methods 200, 300, and 400 and segment analysis system 100.

The memory 502 can comprise any memory media readable by CPU 506 that is capable of storing programming instructions and able to meet the needs of the computing system 500 and execute the programming instructions required for methods 200, 300, and 400 and segment analysis system 100. Memory 502 is generally included to be representative of a random-access memory. In addition, memory 502 may include volatile and non-volatile, removable and non-removable media implemented in any method or technology for storage of information, such as computer-readable instructions or program components. The memory 502 may be implemented as a single memory device but may also be implemented across multiple memory devices or sub-systems. The memory 502 can further include additional elements, such as a controller capable of communicating with the CPU 506.

Illustratively, the memory includes multiple sets of programming instructions for performing the functions of the segment analysis system 100 and methods 200, 300, and 400, including, but not limited to, preprocessing component 110, analysis component 120, counting component 124, influence identification component 130, segmenting component 132, filtering component 142, grouping component 152, and storage component 160, all of which are discussed in greater detail herein. Illustratively, the memory may also include a receiving component 530, a generating component 532, a determining component 534, and a passing component 536. Although memory 502, as depicted in FIG. 5 includes eleven sets of programming instruction components in the present example, it should be understood that one or more components could perform single- or multi-component functions. It is also contemplated that these components of computing system 500 may be operating in a number of physical locations.

The storage 504 can comprise any storage media readable by CPU 506 and is capable of storing data that is able to meet the needs of computing system 500 and store the data required for methods 200, 300, and 400 and segment analysis system 100. The storage 504 may be a disk drive or flash storage device. The storage 504 may include volatile and non-volatile, removable and non-removable media implemented in any method or technology for storage of information. Although shown as a single unit, the storage 504 may be a combination of fixed and/or removable storage devices, such as fixed disc drives, removable memory cards, optical storage, network-attached storage (NAS), or a storage area-network (SAN). The storage 504 can further include additional elements, such as a controller capable of communicating with the CPU 506.

Illustratively, the storage 504 may store data such as but not limited to influence score reports 108, survey score data 112, segment score data 116, final survey data 118, score information 122, survey count 126, user-defined purpose information 128, request data 134, and metric-specific survey score data 144, all of which are also discussed in greater detail herein. Illustratively, the storage 504 may also store data such as but not limited to aggregate scored survey metric data 542, influence data 544, influence score database table data 546, rules governing the automated generation of influence data 548, and report generation rules 550,

Examples of memory and storage media include random access memory, read-only memory, magnetic discs, optical discs, flash memory, virtual memory, and non-virtual memory, magnetic sets, magnetic tape, magnetic disc storage, or other magnetic storage devices, or any other medium which can be used to store the desired software components or information that may be accessed by an instruction execution system, as well as any combination or variation thereof, or any other type of storage medium. In some implementations, one or both of the memory and storage media can be a non-transitory memory and storage media. In some implementations, at least a portion of the memory and storage media may be transitory. Memory and storage media may be incorporated into computing system 500. While many types of memory and storage media may be incorporated into computing system 500, the memory and storage media used is capable of executing the storage requirements of methods 200, 300, and 400 and segment analysis system 100 as described herein.

The I/O interface 510 allows computing system 500 to interface with I/O devices 512. I/O devices 512 can include one or more employee devices 140, graphical user interfaces, desktops, a mouse, a keyboard, a voice input device, a touch input device for receiving a gesture from a user, a motion input device for detecting non-touch gestures and other motions by a user, and other comparable I/O devices and associated processing elements capable of receiving input. The I/O devices 512 through the employee devices 140 are also integrated into the system allowing users to access the telephone system, internet system, and a text communications system, among other systems. I/O devices 512 can also include devices such as a video display or graphical display and other comparable I/O devices and associated processing elements capable of providing output. Speakers, printers, haptic devices, or other types of output devices may also be included in the I/O device 512.

A user can communicate with computing system 500 through the I/O device 512 in order to view influence score reports 108, survey score data 112, segment score data 116, final survey data 118, score information 122, survey count 126, user-defined purpose information 128, request data 134, metric-specific survey score data 144, aggregate scored survey metric data 542, influence data 544, influence score database table data 546, rules governing the automated generation of influence data 548, and/or report generation rules 550 or complete any number of other tasks the user may want to complete with computing system 500. I/O devices 512 can receive and output data such as but not limited to influence score reports 108, survey score data 112, segment score data 116, final survey data 118, score information 122, survey count 126, user-defined purpose information 128, request data 134, metric-specific survey score data 144, aggregate scored survey metric data 542, influence data 544, influence score database table data 546, rules governing the automated generation of influence data 548, and/or report generation rules 550.

As described in further detail herein, computing system 500 may receive and transmit data from and to the network interface 508. In embodiments, the network interface 508 operates to send and/or receive data, such as but not limited to, influence score reports 108, survey score data 112, segment score data 116, final survey data 118, score information 122, survey count 126, user-defined purpose information 128, request data 134, metric-specific survey score data 144, aggregate scored survey metric data 542, influence data 544, influence score database table data 546, rules governing the automated generation of influence data 548, and/or report generation rules 550 to/from other devices and/or systems to which computing system 500 is communicatively connected, and to receive and process interactions as described in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the foregoing description.

What is claimed is:

1. A method for determining influence of question/response combinations in surveys on an aggregate scored survey metric for a set of surveys, the method comprising:
receiving request data including a specific aggregate scored survey metric and a date range;
receiving a set of survey score data for a specific set of surveys from a survey scores database based on the request data;
analyzing the set of survey score data to eliminate one or more surveys from the set of surveys in the set of survey score data that do not correspond to received user-defined purpose information;
generating a set of score information from each survey in the set of survey score data, the set of score information including a score for a scored survey metric corresponding to the aggregate scored survey metric;
determining a score count for the set of survey score data, the score count being a number of surveys in the set of survey score data;
analyzing the set of survey score data to generate segment score data for each question/response combination of a plurality of question/response combinations in the set of surveys of the set of survey score data, the segment score data including the score for the scored survey metric corresponding to the aggregate scored survey metric for each survey including a specific question/response combination and the specific question/response combination;
passing all segment score data, the score information, and the survey count to an analysis component for influence determination;
generating, by the analysis component, influence data for each segment score data based on the score information and the survey count, each influence data including an influence score for the question/response combination associated with a segment score data, the question/response combination associated with the segment score data, and the request data; and
generating an influence score report for the request data based on analysis of the influence scores of the influence data.

2. The method of claim 1, wherein the request data includes a plurality of specific aggregate scored survey metrics each accompanied by its own date range.

3. The method of claim 1, wherein generating influence data includes determining a mean and a standard deviation for the set of surveys in the set of survey score data with set of score information and the score count.

4. The method of claim 3, wherein generating influence data further includes, for each segment score data, determining a segment mean for the scores in the segment score data.

5. The method of claim 1, wherein a negative influence score indicates the specific question/response combination associated with the influence data has a negative influence on the aggregate scored survey metric for the date range, further wherein a positive influence score indicates the specific question/response combination associated with the influence data has a positive influence on the aggregate scored survey metric for the date range.

6. The method of claim 5, the method further comprising ordering the influence data in a numerical order based on the influence score, wherein the influence data with a greatest negative influence score is determined to negatively impact the aggregate scored survey metric more than the influence data with a smallest negative influence score, further wherein the influence data with a greatest positive influence score is determined to positively impact the aggregate scored survey metric more than the influence data with a smallest positive influence score.

7. The method of claim 1, further comprising updating an influence score database with the influence data.

8. A system for determining influence of question/response combinations in surveys on an aggregate scored survey metric for a set of surveys, the system comprising:
a memory comprising computer readable instructions;
a processor configured to read the computer readable instructions that when executed causes the system to:
receive request data including a specific aggregate scored survey metric and a date range;
receive a set of survey score data for a specific set of surveys from a survey scores database based on the request data;
analyze the set of survey score data to eliminate one or more surveys from the set of surveys in the set of survey score data that do not correspond to received user-defined purpose information;
generate a set of score information from each survey in the set of survey score data, the set of score information including a score for a scored survey metric corresponding to the aggregate scored survey metric;
determine a score count for the set of survey score data, the score count being a number of surveys in the set of survey score data;
analyze the set of survey score data to generate segment score data for each question/response combination of a plurality of question/response combinations in the set of surveys of the set of survey score data, the segment score data including the score for the scored survey metric corresponding to the aggregate scored survey metric for each survey including a specific question/response combination and the specific question/response combination;
pass all segment score data, the score information, and the survey count to an analysis component for influence determination;
generate, by the analysis component, influence data for each segment score data based on the score information and the survey count, each influence data including an influence score for the question/response combination associated with a segment score data, the question/response combination associated with the segment score data, and the request data; and
generate an influence score report for the request data based on analysis of the influence scores of the influence data.

9. The system of claim 8, wherein the request data includes a plurality of specific aggregate scored survey metrics each accompanied by its own date range.

10. The system of claim 8, wherein causing the system to generate influence data includes determining a mean and a standard deviation for the set of surveys in the set of survey score data with set of score information and the score count.

11. The system of claim 10, wherein causing the system to generate influence data further includes, for each segment score data, determining a segment mean for the scores in the segment score data.

12. The system of claim 8, wherein a negative influence score indicates the specific question/response combination associated with the influence data has a negative influence on the aggregate scored survey metric for the date range, further wherein a positive influence score indicates the specific question/response combination associated with the influence data has a positive influence on the aggregate scored survey metric for the date range.

13. The system of claim 12, wherein the system is further caused to order the influence data in a numerical order based on the influence score, wherein the influence data with a greatest negative influence score is determined to negatively impact the aggregate scored survey metric more than the influence data with a smallest negative influence score, further wherein the influence data with a greatest positive influence score is determined to positively impact the aggregate scored survey metric more than the influence data with a smallest positive influence score.

14. The system of claim 8, wherein the system is further caused to update an influence score database with the influence data.

15. A non-transitory computer readable medium comprising computer readable code to determine influence of question/response combinations in surveys on an aggregate scored survey metric for a set of surveys on a system that when executed by a processor, causes the system to:
receive request data including a specific aggregate scored survey metric and a date range;
receive a set of survey score data for a specific set of surveys from a survey scores database based on the request data;
analyze the set of survey score data to eliminate one or more surveys from the set of surveys in the set of survey score data that do not correspond to received user-defined purpose information;
generate a set of score information from each survey in the set of survey score data, the set of score information including a score for a scored survey metric corresponding to the aggregate scored survey metric;
determine a score count for the set of survey score data, the score count being a number of surveys in the set of survey score data;
analyze the set of survey score data to generate segment score data for each question/response combination of a plurality of question/response combinations in the set of surveys of the set of survey score data, the segment score data including the score for the scored survey metric corresponding to the aggregate scored survey metric for each survey including a specific question/response combination and the specific question/response combination;
pass all segment score data, the score information, and the survey count to an analysis component for influence determination;
generate, by the analysis component, influence data for each segment score data based on the score information and the survey count, each influence data including an influence score for the question/response combination associated with a segment score data, the question/response combination associated with the segment score data, and the request data; and
generate an influence score report for the request data based on analysis of the influence scores of the influence data.

16. The non-transitory computer readable medium of claim 15, wherein the request data includes a plurality of specific aggregate scored survey metrics each accompanied by its own date range.

17. The non-transitory computer readable medium of claim 15, wherein causing the system to generate influence data includes determining a mean and a standard deviation for the set of surveys in the set of survey score data with set of score information and the score count.

18. The non-transitory computer readable medium of claim 17, wherein causing the system to generate influence data further includes, for each segment score data, determining a segment mean for the scores in the segment score data.

19. The non-transitory computer readable medium of claim 15, wherein a negative influence score indicates the specific question/response combination associated with the influence data has a negative influence on the aggregate scored survey metric for the date range, further wherein a positive influence score indicates the specific question/response combination associated with the influence data has a positive influence on the aggregate scored survey metric for the date range.

20. The non-transitory computer readable medium of claim 19, wherein the system is further caused to order the influence data in a numerical order based on the influence score, wherein the influence data with a greatest negative influence score is determined to negatively impact the aggregate scored survey metric more than the influence data with a smallest negative influence score, further wherein the influence data with a greatest positive influence score is determined to positively impact the aggregate scored survey metric more than the influence data with a smallest positive influence score.
